(19) United States
(12) Patent Application Publication
(10) Pub. No.: US 2017/0023140 A1
(43) Pub. Date: Jan. 26, 2017

(54) HIGH FLOW AND QUICK RESPONSE DISK STYLE CHECK VALVE FOR HYDRAULIC TENSIONER

(71) Applicant: BorgWarner Inc., Auburn Hills, MI (US)

(72) Inventor: Matthew W. CRUMP, Cortland, NY (US)

(21) Appl. No.: 15/039,099

(22) PCT Filed: Nov. 20, 2014
(86) PCT No.: PCT/US2014/066496

§ 371 Date: May 25, 2016

Related U.S. Application Data
(60) Provisional application No. 61/911,102, filed on Dec. 3, 2013.

(51) Int. Cl. F16K 15/02; F16H 7/08

(52) U.S. Cl. CPC F16K 15/025; F16H 7/08; F16H 2007/0812; F16H 2007/0859; F16H 2007/0872; F16H 2007/0893

(57) ABSTRACT

A check valve (30, 130, 230, 330, 430) can include a housing (132, 232, 332, 432) defining a plurality of inlet passages (138, 238, 338, 438) with a corresponding plurality of valve seats (148, 248, 348, 448) and an outlet passage 5 (140, 240, 340, 440) in fluid communication with the inlet passages (138, 238, 338, 438) through a cavity (142, 242, 342, 442). At least one valve disk (144, 244, 344, 444) has at least one valve sealing surface (146, 246, 346, 446) engageable with a corresponding one of the valve seats (148, 248, 348, 448). At least one biasing member (150, 250, 350, 450) normally biases the at least one valve disk (144, 244, 10 344, 444) toward a seated sealed position while allowing reciprocal movement within the cavity (142, 242, 342, 442) to an unseated position spaced from the valve seat (148, 248, 348, 448) allowing fluid flow therethrough.

### FIELD OF THE INVENTION

The invention relates to a check valve apparatus and method of manufacture, and more particularly to a hydraulic tensioner for applying proper tension to an endless, flexible, power transmission member, such as a timing belt or timing chain, encircling a driving sprocket and at least one driven sprocket as used for an internal combustion engine of a motor vehicle.

### BACKGROUND

Chain tensioners in engines are used to control the power transmission chains as the chain travels around a plurality of sprockets. The slack of the chain varies as the temperature in an engine increases and as the chain wears. When a chain wears, the chain elongates and the slack in the chain increases. The increase in slack may cause noise, slippage, or tooth jumping between the chain and the sprocket teeth. If the increase of the slack of the chain is not taken up, by a tensioner for example, in an engine with a chain driven camshaft, the engine may be damaged because the camshaft timing is misaligned by several degrees due to slippage or tooth jumping.

The performance of a hydraulic tensioner is based on two primary functions of a check valve. First, oil must flow through a check valve and into a high pressure chamber of the tensioner as the piston extends to take up chain slack. If the flow restriction of the check valve is too great, the piston will not have enough oil volume to support its extended length. Secondly, as the chain begins to push the piston back into the tensioner the oil wants to flow back out of the check valve. At this point, the oil passage must be sealed off. Current technology utilizes a single check valve ball for sealing this passage. If the response time is too slow it takes longer to build up the necessary pressure to support the piston and chain control becomes an issue.

Hydraulic tensioner check valves have been previously disclosed in U.S. Pat. No. 7,404,776; U.S. Pat. No. 7,427,249; and U.S. Published Application No. 2008/0261737. The current singular check valve ball technology is limited in that it has two methods of increasing flow. The first option is to increase the diameter of the ball which increases the conical flow area between the seat and ball. The adverse effect of increasing the ball diameter is that the ball's mass also increases. As the mass of the ball increases the response time to reverse the direction of the ball to seal off the inlet aperture also increases. The second method of increasing the flow is to increase the travel distance of the ball. Allowing the ball to move further away from the seat will increase the conical flow area, but it also means response time will increase. Neither of these methods provides variable flow.

Ball check valves have been previously disclosed in U.S. Pat. No. 1,613,145; U.S. Pat. No. 2,308,876; U.S. Pat. No. 4,018,247; and U.S. Pat. No. 4,253,524. These non-analogous patents pertain to a casing string of an oil well, a high speed gas compressor, and high pressure reciprocating oil well pumps. While the earliest of these patents was issued in 1927, known hydraulic tensioners have not included variable valve sealing surfaces for a timing chain or timing belt assembly. It is believed that this lack of adaptation is due to the difficulty in designing a cost effective package to contain and control valve sealing surfaces in a small, compact, lightweight configuration.

### SUMMARY

Current hydraulic tensioners use a check valve having a singular check valve ball to control the unidirectional flow of oil into a high pressure chamber of a tensioner. In certain tensioner applications it may be beneficial to vary the stiffness of the piston. It would be desirable to provide a check valve for a hydraulic tensioner which encompasses variable flow characteristics for sealing the inlet oil passage to improve the performance of the hydraulic tensioner. To overcome the limitation of current technology, a check valve can include a plurality of check valve disks in unique patterns of size, allowable travel, and biasing spring forces to achieve variable flow at different inlet fluid pressures as a means of changing piston stiffness. Using multiple smaller and lighter check valve disks can achieve the same or greater flow as one large check valve ball. Additionally, if the proper number of check valve disks is selected, the travel of the disks can be reduced. Since the mass of each disk is greatly reduced, as well as the travel distance, the response time to seal off the fluid inlet is improved. The multiple disk check valve provides a cost effective design to contain and control the plurality of disks in a small, compact, lightweight configuration. To overcome the limitation of current technology, a check valve for a hydraulic tensioner can include a single check valve disk or washer to increase the flow area through the inner diameter of the check valve. The disk or washer can operably engage with respect to a plurality of apertures of varying shapes and/or sizes for optimization of fluid flow through the check valve.

A high flow and quick response check valve can include a housing defining a plurality of inlet passages and an outlet passage in fluid communication with the plurality of inlet passages through a cavity defined by the housing. The check valve can include a plurality of valve seats corresponding to the plurality of inlet passages located within the cavity. The check valve can include at least one valve disk having at least one corresponding valve sealing surface engageable with at least one of the plurality of valve seats. The at least one valve disk can be received within the cavity for reciprocal movement with respect to at least one of the plurality of valve seats and can normally be biased toward at least one of the plurality of valve seats. The check valve can include at least one biasing member received within the cavity of the housing for normally biasing the at least one valve disk toward the corresponding at least one of the plurality of valve seats into a seated sealed position to prevent fluid flow, while allowing for movement of the at least one valve disk to an unseated or open position located at a position spaced from the corresponding at least one of the plurality of valve seats allowing fluid flow through the check valve.

A method of manufacturing a high flow and quick response check valve can include the steps of forming a housing to define a plurality of inlet passages, an outlet passage, and a cavity defined within the housing allowing fluid communication between the plurality of inlet passages and the outlet passage. The method can include forming a plurality of valve seats corresponding to the plurality of inlet passages located within the cavity defined by the housing. The method can include inserting at least one valve disk into the cavity defined by the housing. The at least one valve disk can include at least one corresponding valve sealing surface sealingly engageable with at least one of the plurality of valve seats. The at least one valve disk can be received within the cavity defined by the housing. The at least one valve disk can reciprocally move with respect to the corresponding at least one of the plurality of valve seats and can be normally biased toward the corresponding at least one of the plurality of valve seats. The method can include inserting at least one biasing member into the cavity defined by the housing. Each biasing member can be received within the cavity defined by the housing for normally biasing at least one valve disk toward the corresponding at least one of the plurality of valve seats to a seated, sealed position to prevent fluid flow, while allowing for movement of the at least one valve disk into an unseated or open position located spaced from the corresponding at least one of the plurality of valve seats to allow fluid flow.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a cross sectional view of a high flow and quick response check valve having a plurality of check valve disks, each valve disk having a generally planar valve sealing surface;

FIG. 2 is a cross sectional view of a high flow and quick response check valve having a plurality of check valve disks, each valve disk having a generally curved valve sealing surface;

FIG. 3 is a cross sectional view of a high flow and quick response check valve having a single check valve disk or washer with a generally planar valve sealing surface;

FIG. 4 is a cross sectional view of a high flow and quick response check valve having a single check valve disk or washer with at least one generally curved valve sealing surface;

FIG. 5A is a simplified schematic illustrating a plurality of check valve disks, a connecting member assembling the plurality of check valve disks into a single unitary valve member, and a plurality of spring levers located at angularly spaced positions about a circumference of the connecting member between adjacent pairs of connected check valve disks;

FIG. 5B is a simplified schematic of a check valve disk having a generally curved valve sealing surface;

FIG. 5C is a simplified schematic of one of the plurality of spring levers as shown in FIG. 5A;

FIG. 6 is a bottom view of the high flow and quick response check valve illustrating the plurality of inlet passages;

FIG. 7 is a top view of the plurality of check valve disks, the connecting member, and the plurality of spring levers as shown in FIGS. 5A and 5C;

FIG. 8 is a top view of the check valve illustrating the housing having a plurality of compartment tabs and a plurality of individual, separate check valve disks inserted in the housing for independent movement with respect to one another, where different spring forces can be provided acting to bias each individual check valve disk toward a corresponding valve seat to a seated, sealed position;

FIG. 9 is a top view of the plurality of individual separate check valve disks;

FIG. 10 is a detail cross sectional view of a portion of a single valve disk having a generally planar valve sealing surface;

FIG. 11 is a detail cross sectional view of a portion of a single valve disk having a generally curved valve sealing surface;

FIG. 12 is a detail side view of one of the plurality of valve disks having a generally planar valve sealing surface;

FIG. 13 is a detail side view of one of the plurality of valve disks having a generally curved valve sealing surface;

FIG. 14 is a simplified schematic of a hydraulic tensioner for an endless loop, flexible, power transmission member, such as a timing chain or timing belt, for an internal combustion engine, including a high flow and quick response check valve having at least one check valve disk according to the present invention; and

FIG. 15 is a graph illustrating flow (cc/sec) versus pressure (psi) with a curve corresponding to a single check valve disk, a curve corresponding to a high flow check valve with a plurality of valve disks, and a curve corresponding to a variable flow multiple disk check valve having a plurality of check valve disks operable independently of one another with different spring biasing forces operating against at least some of the individual separate check valve disks allowing for different pop off pressures.

### DETAILED DESCRIPTION

The term “belt” or “chain”, as used interchangeably herein, is any power transmission member forming an endless loop and constructed of flexible material or of articulated rigid links to permit the member to conform to a radius of curvature of a pulley or sprocket drive face and intended, in use, to be driven in an endless path; and, by contact with the pulley or sprocket drive face, to transmit power to or extract power from the pulley or sprocket. The term a “pulley” or “sprocket”, as used interchangeably herein, is a device rotatable about an axis and having a drive face radially spaced from the axis of rotation for intended power transferring engagement with a belt or chain to drive the belt or chain on an endless path or to extract power from the belt or chain to drive an output load device. The term “guide roll” as used herein is a device rotatable about an axis and having a belt or chain-contacting face radially spaced from the axis of rotation for intended engagement with the belt or chain to aid in directing the belt or chain along an intended path of travel. A guide roll, as distinguished from a pulley or sprocket, is not intended to provide driving power to, or extract power from, a belt or chain. The term “tensioning arm” as used herein is a member other than a pulley or sprocket engageable with a belt or chain, and which is adjustable or relatively movable with respect to the belt or chain in a direction which causes an increase or decrease in tensile stress in the belt or chain or a take-up or any undesirable belt or chain slack to maintain a desirable drive traction between the belt or chain and the pulley or sprocket drive face. A tensioning arm, as distinguished from a guide roll, has a non-rotatable face portion for contacting the belt or chain, whereby the belt or chain slides over the face portion of the tensioning arm. The term “hydraulic tensioner” or “tension drive mechanism” as used herein applies a force for actuating the tensioning arrangement and is derived from or transmitted via the exertion of force on a fluid.

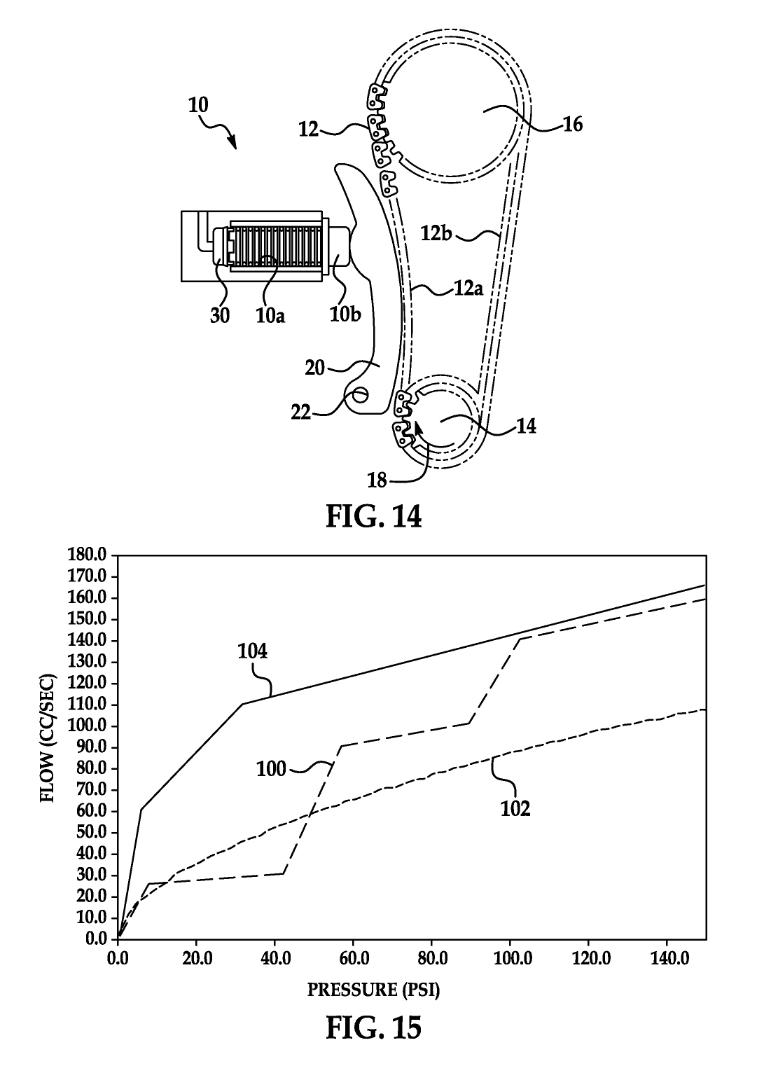

Referring now briefly to FIG. 14, a hydraulic tensioner 10 is schematically illustrated for an endless loop, flexible, power transmission member 12 for an internal combustion engine of a motor vehicle. The power transmission member 12 encircles a drive sprocket 14 driven by a drive shaft, such as a crank shaft of the engine, and at least one driven sprocket 16 supported from a driven shaft, such as a cam shaft of the engine. A guide roll can also be provided, if desired. The power transmission member 12 passes over the drive sprocket 14 and driven sprockets 16 to define a slack strand 12a and a taut strand 12b, when driven in rotation as shown by arrow 18. On the outside of at least one of the slack strand 12a and the taut strand 12b of the power transmission member 12, at least one tensioning arm 20 is positioned with a face assembly including a shoe for sliding engagement with the power transmission member 12. The tensioning arm 20 can rotate about pivot 22 in response to force exerted by the tension drive mechanism or hydraulic tensioner 10. Rotation of the tensioning arm 20 about the pivot 22 applies tension to the power transmission member 12 to remove excess slack. In operation, the variable flow check valve 30 controls the unidirectional flow of hydraulic oil into a high pressure chamber 10a of a hydraulic tensioner 10 to support a piston 10b in operable engagement with the tensioning arm 20 to maintain tension on the power transmission member 12 in order to remove excess slack. In other words, as pressure increases beyond the check valve biasing force of at least one of the valve disk members of check valve 30, hydraulic oil flows through the at least one valve seat opening of the check valve 30 and into a high pressure chamber 10a of the tensioner 10 as the piston 10b extends to take up slack in the power transmission member 12. It should be recognized that the hydraulic tensioner 10 disclosed below can be used in other alternative configurations of tensioning arms without departing from the spirit or scope of the present invention, and that the illustrated configuration is by way of example only, and is not to be considered a limitation of the invention.

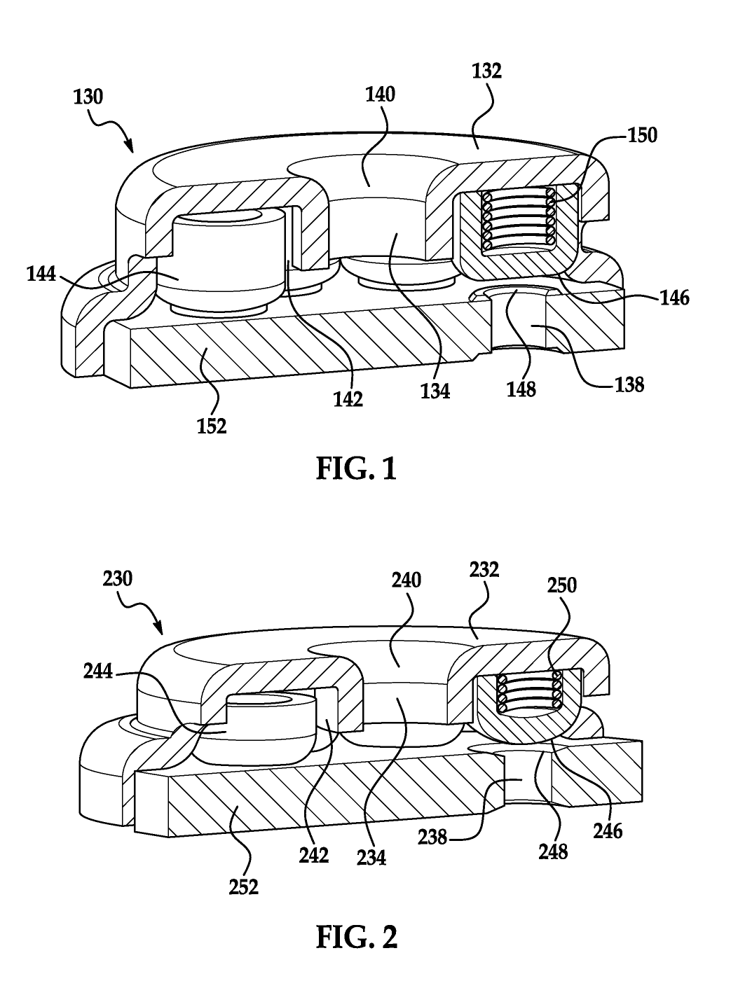

Referring now to FIGS. 1-13, an improvement of a high flow and quick response, and/or variable flow, check valve 130, 230, 330, 430 for a hydraulic tensioner 10 is illustrated. The check valve 130, 230, 330, 430 can include a housing 132, 232, 332, 432 defining a plurality of inlet passages 138, 238, 338, 438 for receiving hydraulic oil, an outlet passage 140, 240, 340, 440, and defining an internal cavity 142, 242, 342, 442. The outlet passage 140, 240, 340, 440 can be in fluid communication with the plurality of inlet passages 138, 238, 338, 438 through the internal cavity 142, 242, 342, 442. The check valve 130, 230, 330, 430 can include a plurality of valve seats 148, 248, 348, 448 corresponding to the plurality of inlet passages 138, 238, 338, 438. The plurality of valve seats 148, 248, 348, 448 can be located within the internal cavity 142, 242, 342, 442. The check valve 130, 230, 330, 430 can include at least one valve disk 144, 244, 344, 444 and at least one biasing member 150, 250, 350, 450. Each of the at least one valve disk 144, 244, 344, 444 can have at least one valve sealing surface 146, 246, 346, 446 and can be received within the internal cavity 142, 242, 342, 442 of the housing 132, 232, 332, 432 for reciprocal movement towards and away from the corresponding at least one of the plurality of valve seats 148, 248, 348, 448. At least one biasing member 150, 250, 350, 450 can also be received within the cavity 142, 242, 342, 442 for normally biasing at least one valve disk 144, 244, 344, 444 toward the corresponding at least one valve seat 148, 248, 348, 448 and a seated, sealed position, while allowing for the movement of at least one valve disk 144, 244, 344, 444 from the seated sealed position to an unseated position spaced from the corresponding at least one of the plurality of valve seats 148, 248, 348, 448 allowing fluid flow in response to a difference in fluid pressure. In other words, when fluid pressure acting against the valve sealing surface of the valve disk is greater than the spring force of the biasing member, the fluid pressure moves the valve disk from the seated position to the unseated position allowing fluid flow therethrough.

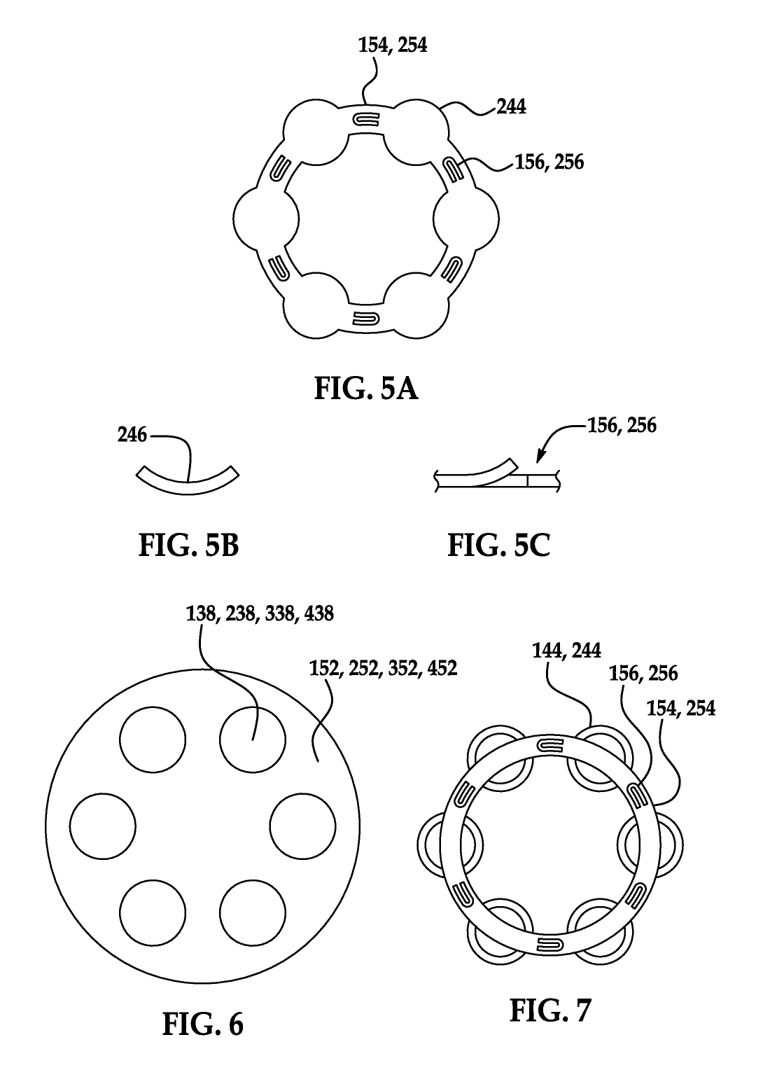

By way of example and not limitation, the plurality of inlet passages 138, 238, 338, 438 can be defined by a plate 152, 252, 352, 452 formed of a stamped sheet metal material. The plurality of valve seats 148, 248, 348, 448 can be formed in the plate 152, 252, 352, 452, or can be formed of an injection molded plastic overmolded with respect to the corresponding plurality of inlet passages 138, 238, 338, 438 located on the plate 152, 252, 352, 452. The housing 132, 232, 332, 432 can be formed of an injection molded plastic to define the cavity 142, 242, 342, 442 when assembled with respect to the plate 152, 252, 352, 452. At least one valve disk 144, 244, 344, 444, and at least one biasing member 150, 250, 250, 450 can be assembled within the internal cavity 142, 242, 342, 442 defined between the assembled housing 132 232 332, 432 and plate 152, 252, 352, 452. The outlet passage 140, 240, 340, 440 formed in the housing 132, 232, 332, 432 can be in fluid communication with the plurality of inlet passages 138, 238, 338, 438 through the plurality of valve seats 148, 248, 348, 448 of the at least one plate 152, 252, 352, 452 and through the internal cavity 142, 242, 342, 442 defined between the housing 132, 232, 332, 432 and the plate 152, 252, 352, 452. At least one biasing member 150, 250, 350, 450 can be formed as a helically coiled compression spring as best seen in FIGS. 1-4, and/or can be formed of a stamped sheet metal material such as a leaf, or cantilevered, spring as best seen in FIGS. 5A and 5C.

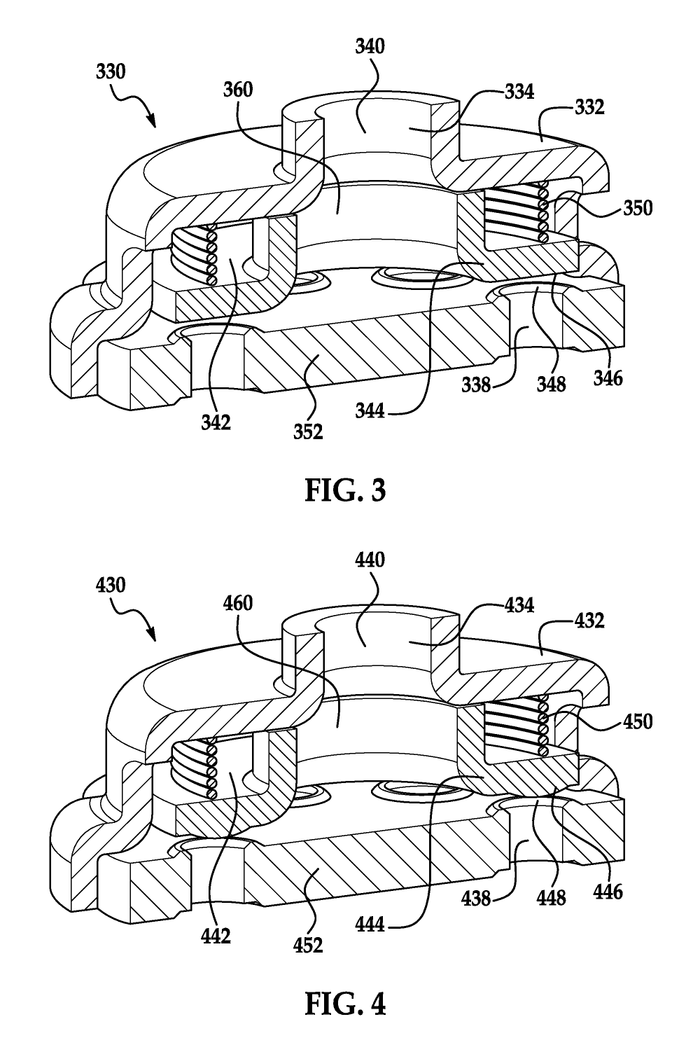

Referring now to FIGS. 1-2, the present invention can include a plurality of valve disks 144, 244 as illustrated. The hydraulic tensioner 10 as illustrated can overcome the limitations of current technology by incorporating the use of a plurality of valve disks 144, 244, where each valve disk 144, 244 has a corresponding valve sealing surface 146, 246 engageable with a corresponding valve seat 148, 248. The housing 132, 232 can define a plurality of inlet passages 138, 238, an outlet passage 140, 240, and an internal cavity 142, 242 defined between the housing 132, 232 and the plate 152, 252. By way of example and not limitation, the outlet passage 140, 240 can be defined by an interior surface 134, 234 of the housing 132, 232 extending inwardly and into the cavity 142, 242 for a more compact check valve configuration. It should be recognized by those skilled in the art that the outlet passage 140, 240 can be defined by an interior surface of the housing extending outwardly away from the cavity 142, 242 similar to FIGS. 3 and 4, if desired. The plurality of inlet passages 138, 238 can be formed in the plate 152, 252. The plurality of valve seats 148, 248 corresponding to the plurality of inlet passages 138, 238 can be formed in the plate 52, 252 and located within the internal cavity 142, 242. The internal cavity 142, 242 can also receive the plurality of valve disks 144, 244 and at least one biasing member 150, 250 for each valve disk 144, 244.

Referring now to FIG. 1, at least one of the plurality of valve disks 144 can have a planar sealing surface 146 for sealing engagement with the corresponding valve seat 148. FIG. 12 is a detail view illustrating a cross section of at least one valve disk 144 having a planar sealing surface 146 with a generally planar shaped surface for sealing engagement with the corresponding valve seat 148 according to the check valve 130 illustrated in FIG. 1.

Referring now to FIG. 2, at least one of the plurality of valve disks 244 can have a valve sealing surface 246 which is generally curved or generally cupped in shape. FIG. 13 is a detail view illustrating a cross section of at least one valve disk 244 having a valve sealing surface 246 with a generally curved shaped, or generally cupped shaped, surface for sealing engagement with the corresponding valve seat 248.

The plurality of valve disks 144, 244 illustrated in FIGS. 1-2 can have uniform or independent reciprocal movement with respect to the plurality of valve seats 148, 248. Referring to FIG. 5A, the valve disks 144, 244 can be held or restrained with respect to one another in order to provide uniform displacement of valve members simultaneously within the cavity 142, 242 by a connecting member 154, 254. The connecting member 154, 254 can be a stamped metal preform with injection molded valve members formed with respect thereto, or can be formed as an integral injection molded plastic piece with the connecting member and valve members formed simultaneously into a single unitary valve disk member for synchronized reciprocal movement within the cavity 142, 242 of the housing 132, 232. Each valve disk 144, 244 can be fixedly connected to the connecting member 154, 254. As illustrated in detail in FIG. 5C, the biasing member 150, 250 in the depicted check valves can use a connecting member 154, 254 formed with a plurality of spring levers 156, 256 located on the connecting member 154, 254 for biasing engagement between the connecting member 154, 254 and the housing 132, 232, providing for uniform reciprocal movement of the plurality of valve disks 144, 244 with respect to the plurality of valve seats 148, 248. The plurality of spring levers 156, 256 can be used for uniformly biasing the plurality of valve disks 144, 244 toward a seated position against the corresponding plurality of valve seats 148, 248 and allowing for the uniform movement of the plurality of valve disks 144, 244 to an unseated position spaced from the plurality of valve seats 148, 248 allowing fluid flow. The plurality of valve disks 144, 244, the connecting member 154, 254, and the plurality of spring levers 156, 256 can be received within the cavity 142, 242. FIG. 7 illustrates a top view of the plurality of valve disks 144, 244, the connecting member 154, 254, and the plurality of spring levers 156, 256.

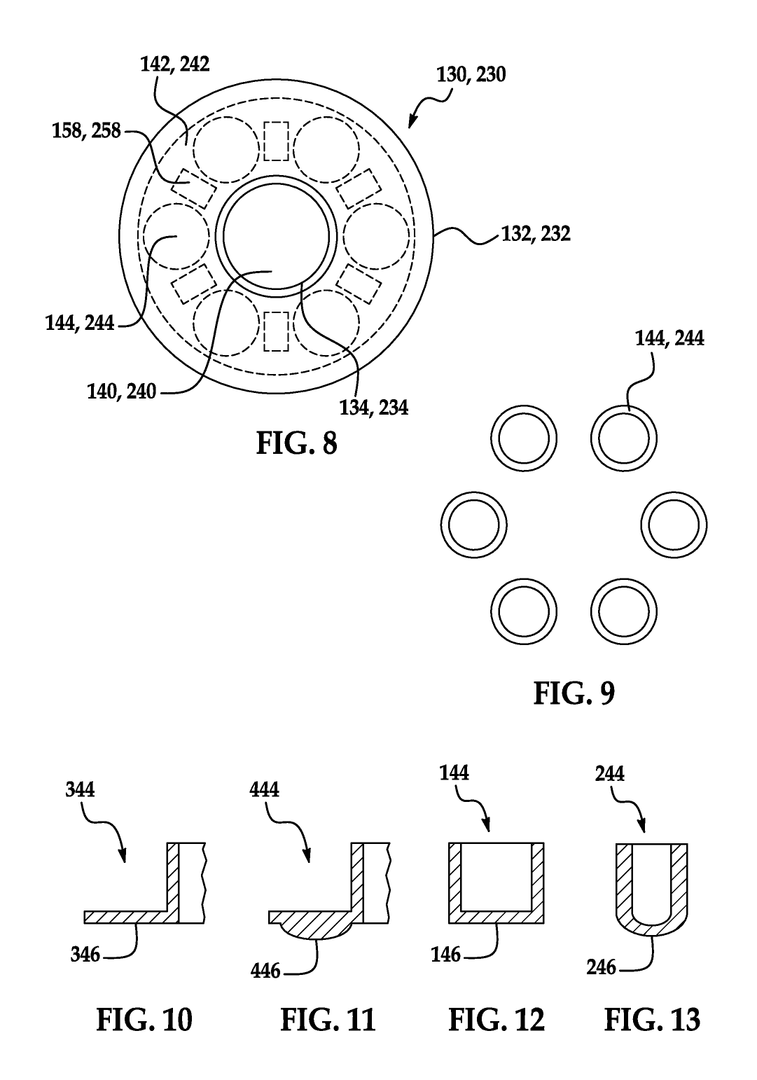

As best seen in FIGS. 8-9, a plurality of separate individual valve disks 144, 244 can be compartmentalized for separate individual movement within the housing 132, 232 with inwardly extending or projecting compartment tabs 158, 258 providing for independent movement of each valve disk 144, 244. The compartment tabs 158, 258 can be formed as part of the cover 132 and/or as part of the plate 152. As illustrated in FIG. 8, the housing 132, 232 can have a plurality of compartment tabs 158, 258 adjacent to each valve disk 144, 244. The plurality of compartment tabs 158, 258 can be molded within the housing 132, 232. Each compartment tab 158, 258 can guide at least one valve disk 144, 244 during displacement with respect to the corresponding valve seat 148, 248 and can allow for the reciprocal movement of at least one valve disk 144, 244 with respect to the corresponding valve seat 148, 248. The plurality of compartment tabs 158, 258 can allow for the separate, independent movement of each valve disk 144, 244. At least one biasing member 150, 250 can be provided for biasing each valve disk 144, 244 normally toward a seated position against the corresponding valve seat 148, 248 and allowing for the movement of at least one valve desk 144, 244 to an unseated or open position spaced from the corresponding valve seat 148, 248 allowing fluid flow therethrough. The at least one biasing member 150, 250 can be in the form of at least one compression spring operably engageable between the at least one valve disk 144, 244 and the housing 132, 232. The compression spring can be compressed to allow the at least one valve disk 144, 244 to move to an unseated position spaced from the corresponding valve seat 148, 248 in response to fluid pressure acting on the surface of the valve disk 144, 244.

The check valves 130, 230 illustrated in FIGS. 1-2 can increase flow and response time within a hydraulic tensioner 10. By using a plurality of valve disks 144, 244 for sealing the plurality of valve seats 148, 248, greater flow can be achieved as compared with one large check valve ball. Using a plurality of light weight valve disks can also decrease the response time required for movement of the valve disk 144, 244 with respect to the corresponding one of the plurality of inlet passages 138, 238. Additionally, depending on the number of valve disks 144, 244 selected, the reciprocal travel distance of each valve disk 144, 244 can be reduced. The valve disks 144, 244 offer the advantage of requiring a smaller housing 132, 232, providing for a compact check valve 130, 230.

Referring now to FIGS. 3-4, check valves 330, 430 are illustrated using a single valve disk 344, 444. The single valve disk 344, 444 can have a plurality of generally planar valve sealing surfaces 346 as best seen in FIG. 3, or a plurality of generally curved, or generally cupped, valve sealing surfaces 446 as best seen in FIG. 4. A housing 332, 432 can be provided to enclose the valve disks 344, 444. The housing 332, 432 can define a plurality of inlet passages 338, 438, an outlet passage 340, 440, and a cavity 342, 442. The outlet passage 340, 440 can be defined by the interior surface 334, 434 of the housing 332, 432 extending outwardly and away from the cavity 342, 442, decreasing any resistance of the housing 332, 432 against flow from the plurality of inlet passages 338, 438. It should be recognized by those skilled in the art that the outlet passage 340, 440 can be defined by an interior surface of the housing extending inwardly into the cavity 342, 442 similar to that illustrated in FIGS. 1 and 2, if desired. The plurality of inlet passages 338, 438 can be formed in the plate 352, 452. The plurality of valve seats 348, 448 corresponding to the plurality of inlet passages 338, 438 can be formed in the plate 352, 452, which is assembled with respect to the housing 332, 432 to define the cavity 342, 442. The cavity 342, 442 can also receive and enclose the single valve disk 344, 444 and at least one biasing member 350, 450. The single valve disk 344, 444 can be in the form of a cylinder having an outwardly extending flange or washer adjacent one end to define at least one central opening 360, 460.

As illustrated in FIG. 3, the single valve disk 344 can have a plurality of planar valve sealing surfaces 346 formed as a single generally planar surface as best seen in FIG. 10 to engage and seal the corresponding plurality of valve seats 348. As illustrated in FIG. 4, the single valve disk 444 can have a plurality of valve sealing surfaces 446 formed as a single generally planar disk with a plurality of complementary generally curved, or generally cupped, valve sealing surfaces located on the generally planar disk as best seen in FIG. 11 to engage and seal the corresponding valve seats 448. The complementary curved surfaces can take the form of cupped edges for guiding valve sealing surface engagement with the corresponding valve seat. At least one biasing member 350, 450 can be provided for biasing the single valve disk 344, 444 normally toward a seated sealed position against the plurality of valve seats 348, 448 and for allowing movement from the seated and sealed position to an unseated or open position spaced from the valve seat 348, 448 allowing fluid flow. The biasing member 350, 450 can be a single compression spring engageable between the single valve disk 344, 444 and the housing 332, 432. An advantage of the single valve disk configuration is an increased flow concentrated through an inner diameter of the housing 332, 432. By way of example and not limitation, the illustrated configurations shown in FIGS. 3-4 depict the single valve disk as having a central opening 360, 460 located at a central location on the valve disk. The central opening 360, 460 can be of any shape and position to maximize the flow area.

A method of manufacturing a high flow and quick response check valve 130, 230, 330, 430 can include forming a housing 132, 232, 332, 432 to define a plurality of inlet passages 138, 238, 338, 438, an outlet passage 140, 240, 340, 440 and a cavity 142, 242, 342, 442 located between the plurality of inlet passages 138, 238, 338, 438 and the outlet passage 140, 240, 340, 440. The housing 132, 232, 332, 432 can be formed by injection molding. The method can further include stamping the plurality of inlet passages 138, 238, 338, 438 into a sheet of metal material. The method can include processing a sheet of metal material. A plate 152, 252, 352, 452 can be formed by molding a plurality of valve seats 148, 248, 348, 448 over the corresponding plurality of inlet passages 138, 238, 338, 438 processed in the sheet of metal material. The plurality of valve seats 148, 248, 348, 448 can be positioned within the cavity 142, 242, 342, 442 by assembling a housing 132, 232, 332, 432 to the plate 152, 252, 352, 452. At least one valve disk 144, 244, 344, 444 can be positioned within the cavity 142, 242, 342, 442 defined therebetween. The at least one valve disk 144, 244, 344, 444 can be received within the cavity 142, 242, 342, 442 for reciprocal movement with respect to at least one of the plurality of valve seats 148, 248, 348, 448 and can be normally biased into sealing engagement against the corresponding at least one of the plurality of valve seats 148, 248, 348, 448. At least one biasing member 150, 250, 350, 450 can be assembled within the cavity 142, 242, 342, 442 interposed between the at least one valve disk 144, 244, 344, 444 and housing 132, 232, 332, 432. As best seen in FIGS. 1-4, the at least one biasing member 150, 250, 350, 450 can be formed as a coil spring and received within the cavity 142, 242, 342, 442 for normally biasing at least one valve disk 144, 244, 344, 444 toward at least one of the plurality of valve seats 148, 248, 348, 448 to a seated sealed position and allowing for the movement of the valve disk 144, 244, 344, 444 from the seated sealed position to an unseated or open position spaced from at least one of the plurality of valve seats 148, 248, 348, 448 allowing fluid flow therethrough.

As best seen in FIGS. 5A-5C and 7, the method can further include forming a connecting member 154, 254. The connecting member 154, 254 can be injection molded or stamped from a sheet of metal material or a combination thereof. The plurality of valve disks 144, 244 can be fixedly connected to the connecting member 154, 254. The plurality of valve disks 144, 244 and the connecting member 154, 254 can be formed as a single unitary body. The cavity 142, 242 can receive the connecting member 154, 254 and the plurality of valve disks 144, 244. The at least one biasing member 150, 250 can be formed as a plurality of spring levers 156, 256. By way of example and not limitation, the plurality of spring levers 156, 256 can be formed of a stamped sheet metal, or any other suitable material. The connecting member 154, 254, the plurality of spring levers 156, 256, and the plurality of valve disks 144, 244 can be inserted in the cavity 142, 242. The at least one biasing member 156, 256 can be formed as a stamped sheet metal leaf spring and received within the cavity 142, 242, 342, 442 for normally biasing at least one valve disk 144, 244, 344, 444 toward at least one of the plurality of valve seats 148, 248, 348, 448 to a seated sealed position and allowing for the movement of the valve disk 144, 244, 344, 444 from the seated sealed position to an unseated or open position spaced from at least one of the plurality of valve seats 148, 248, 348, 448 allowing fluid flow therethrough. It should be recognized that the plurality of valve disks 144, 244 and the connecting member 154, 254 can be formed as a single unitary body and biased by at least one biasing member formed as at least one coil spring similar to that shown in FIGS. 1-4, if desired.

As best seen in FIG. 8, the method can further include forming a plurality of compartment tabs 158, 258 by molding the housing 132, 232 and inserting one of the plurality of valve disks 144, 244 into the cavity 142, 242 interposed between each adjacent pair of compartment tabs 158, 258. The assembly of individual separate valve disks 144, 244 within the cavity 142, 242 allows for the independent movement of each valve disk 144, 244 within the housing 132, 232. The plurality of compartment tabs 158, 258 can assist in guiding the independent reciprocal movement of the individual separate valve disks 144, 244 with respect to one another and with respect to the corresponding valve seat, while allowing the reciprocal movement of each valve disk to be varied depending on a potentially different spring force selected for each valve disk. Selection of different spring forces can provide a progressive valve disk operation if desired to vary the fluid flow characteristics for a particular application of the check valve 130, 230.

In operation, the high flow and quick response check valve 130, 230, 330, 430 controls the unidirectional flow of hydraulic oil into a high pressure chamber 10a of the hydraulic tensioner 10. The check valve 130, 230, 330, 430 can provide variable flow to improve the performance of the hydraulic tensioner 10. Performance of the hydraulic tensioner 10 can be based on two primary functions of the check valve 130, 230, 330, 430. First, oil must flow through the check valve 130, 230, 330, 430 and into the high pressure chamber 10a of the tensioner 10 as the piston 10b extends to take up chain slack in the power transmission member 12. If the flow restriction of the check valve 130, 230, 330, 430 is too great, the piston 10b will not have enough oil volume to support an extended length. Secondly, as the chain of the power transmission member 12 begins to push the piston 10b back into the hydraulic tensioner 10, the oil wants to flow back out of the check valve 130, 230, 330, 430. At this point, at least one valve disk 144, 244, 344, 444 must seal off the plurality of oil inlet passages 138, 238, 338, 438 by moving back to a seated position in reverse sequence against the plurality of valve seats 148, 248, 348, 448 corresponding to the plurality of inlet passages 138, 238, 338, 438.

In operation, the use of a plurality of valve disks 144, 244 can provide a variable flow to overcome the deficiencies of a single ball check valve configuration. Using a plurality of smaller and lighter valve disks 144, 244 can achieve the same or greater flow as one large check valve ball. Additionally, the travel distance of the valve disks 144, 244 can be reduced. Since the mass of each valve disk 144, 244 is greatly reduced, as well as the travel distance, the response time to seal off the plurality of inlet passages 138, 238 can be improved. Accordingly, the invention can provide a cost effective design to contain and control the plurality of valve disks 144, 244 in a small, compact, lightweight configuration check valve 130, 230.

Variable flow can be achieved by providing at least two of the valve disks 144, 244 with at least one different fluid flow characteristic selected from a group of different fluid flow characteristics including a different disk size, a different allowable disk travel distance, and a different disk biasing force. These characteristics can be different on a singular basis or in any permissible combination thereof. By way of example and not limitation, at least one different fluid flow characteristic can include: at least two of the plurality of valve disks 144, 244 having different valve disk sizes or diameters; or at least two of the plurality of valve disks 144, 244 having different allowable valve disk travel distances; or at least two of the plurality of valve disks 144, 244 having different biasing forces applied thereto; or in combination at least two of the plurality of valve disks 144, 244 having different sizes and different allowable travel distances; or in combination at least two of the plurality of valve disks 144, 244 having different sizes and different biasing forces applied thereto; or in combination at least two of the plurality of valve disks 144, 244 having different allowable travel distances and different biasing forces applied thereto; or in combination at least two of the plurality of valve disks 144, 244 having different sizes, different allowable travel distances, and different biasing forces applied thereto. By varying these characteristics or parameters, individually and in any permissible combination, an infinite number of curves having different flow to pressure characteristics can be produced to meet any particular application design requirement.

Referring to FIG. 15, by way of example and not limitation, a graph compares flow (cc/sec) versus pressure (psi) for a single ball check valve in curve 102, a high flow/quick response multiple disk check valve (having three disks of uniform disk size, uniform disk travel distance, and uniform biasing force applied thereto) in curve 104, and a variable flow multiple disk check valve (having at least two valve disks 144, 244 of non-uniform size, and/or non-uniform travel distance, and/or non-uniform biasing force applied thereto) in curve 100 according to the invention disclosed. It should be recognized that the flow versus pressure graph curves illustrated can be different from that depicted depending on the number of valve disks 144, 244 selected, the disk size selected for each valve disk 144, 244, the allowable disk travel distance selected for each disk, and the biasing force to be applied selected for each valve disk 144, 244. By way of example and not limitation, as depicted in FIG. 15 in curve 100, each valve disk 144, 244 is tuned to pop-off at a different pressure with unique flow characteristics.

In operation, the use of a single valve disk 344, 444 as a washer to provide variable flow also overcomes the deficiencies of a single ball check valve configuration. The benefit of the washer configuration is increased flow directed through the inner diameter of the housing 332, 432. Accordingly, the configuration can provide a cost effective design to contain and control the single valve disk 344, 444 in a small, compact, lightweight configuration check valve 330, 430.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A high flow and quick response check valve (30, 130, 230, 330, 430) comprising:
a housing (132, 232, 332, 432) defining a plurality of inlet passages (138, 238, 338, 438) with a corresponding plurality of valve seats (148, 248, 348, 448), and an outlet passage (140, 240, 340, 440) in fluid communication with the plurality of inlet passages (138 238 338 438) through a cavity (142, 242, 342, 442);
at least one valve disk (144, 244, 344, 444) having at least one valve sealing surface (146, 246, 346, 446) engageable with at least one of the corresponding plurality of valve seats (148, 248, 348, 448), the at least one valve disk (144, 244, 344, 444) received within the cavity (142, 242, 342, 442) for reciprocal movement with respect to the at least one of the corresponding plurality of valve seats (148, 248, 348, 448) and normally biased toward the at least one of the corresponding plurality of valve seats (148, 248, 348, 448); and
at least one biasing member (150, 250, 350, 450) received within the cavity (142, 242, 342, 442) for biasing the at least one valve disk (144, 244, 344, 444) toward the at least one of the corresponding plurality of valve seats (448, 248, 348, 448) while allowing reciprocal movement of the at least one valve disk (144, 244, 344, 444) from a seated sealed position to an unseated position spaced from the at least one of the corresponding plurality of valve seats (148, 248, 348, 448) allowing fluid flow therethrough.

2. The high flow and quick response check valve (30, 130, 330) of claim 1, wherein the at least one valve sealing surface (146, 346) of the at least one valve disk (144, 344) further comprises:
a planar sealing surface (146, 346) sealingly engageable with the at least one of the corresponding plurality of valve seats (148, 348).

3. The high flow and quick response check valve (30, 230, 430) of claim 1, wherein the at least one valve sealing surface (246, 446) of the at least one valve disk (244, 444) further comprises:
a curved valve sealing surface (246, 446) extending outwardly from the at least one valve disk (244, 444) and sealingly engageable with the at least one of the corresponding plurality of valve seats (248, 448).

4. The high flow and quick response check valve (30, 330) of claim 1, wherein the at least one valve disk (344) further comprises:
a single valve disk (344) having a plurality of valve sealing surfaces (346) formed as a single generally planar surface, wherein each of the valve sealing surfaces (346) is planar and sealingly engageable with at least one of the corresponding plurality of valve seats (348).

5. The high flow and quick response check valve (30, 430) of claim 1, wherein the at least one valve disk (444) further comprises:
a single valve disk (444) having a plurality of valve sealing surfaces (446) formed on a single generally planar surface, wherein each of the plurality of valve sealing surfaces (446) is curved outwardly from the at least one valve disk (444) and sealingly engageable with at least one of the plurality of valve seats (448).

6. The high flow and quick response check valve (30, 130, 230) of claim 1, wherein the at least one valve disk (144, 244) further comprises:
a plurality of valve disks (144, 244), each valve disk (144, 244) having a corresponding valve sealing surface (146, 246) sealingly engageable with at least one of the corresponding plurality of valve seats (148, 248), at least two of the plurality of valve disks (144, 244) having different fluid flow characteristics with respect to one another, the different fluid flow characteristic selected from a group including different valve disk sizes, different allowable valve disk travel distances, different valve disk biasing forces, and any combination thereof.

7. The high flow and quick response check valve (30, 130, 230) of claim 1 further comprising:
the at least one valve disk (144, 244) including a plurality of valve disks (144, 244);
a connecting member (150, 250) assembling the plurality of valve disks (144, 244) into a single unitary valve disk member for synchronized reciprocal movement within the cavity (142, 242) of the housing (132, 232); and
at least one biasing member (156, 256) for biasing the plurality of valve disks (144, 244) toward the corresponding plurality of valve seats (148, 248) and allowing synchronized reciprocal movement from the seated sealed position to the unseated position spaced from the corresponding plurality of valve seats (148, 248) allowing fluid flow therethrough.

8. The high flow and quick response check valve (30, 130, 230) of claim 1 further comprising:
the at least one valve disk (144, 244) including a plurality of valve disks (144, 244); and
a plurality of compartment tabs (158, 258) located within the cavity (142, 242) interposed between adjacent valve disks (144, 244), the plurality of compartment tabs (158, 258) compartmentalizing the cavity (142, 242) for guiding the plurality of valve disks (144, 244) during reciprocal movement with respect to the corresponding plurality of valve seats (148, 248), and allowing for separate independent movement of the plurality of valve disks (144, 244) with respect to one another from the seated sealed position to the unseated position spaced from the corresponding plurality of valve seats (148, 248) allowing fluid flow therethrough.

9. The high flow and quick response check valve (30, 130, 230, 330, 430) of claim 1, wherein the housing (132, 232, 332, 432) further comprises at least in part:
at least one plate (152, 252, 352, 452) defining the plurality of inlet passages (138, 238, 338, 438) with the corresponding plurality of valve seats (148, 248, 348, 448).

10. The high flow and quick response check valve (30, 130, 230, 330, 430) of claim 1, wherein the at least one biasing member (150, 250, 350, 450) further comprises:
at least one compression spring operably engageable between the at least one valve disk (144, 244, 344, 444) and the housing (132, 232, 332, 432), the at least one compression spring biasing the at least one valve disk (144, 244, 344, 444) toward at least one of the corresponding plurality of valve seats (148, 248, 348, 448) and allowing reciprocal movement of the at least one valve disk (144, 244, 344, 444) from the seated sealed position to the unseated position spaced from at least one of the corresponding plurality of valve seats (148, 248, 348, 448) allowing fluid flow therethrough.

11. A method of manufacturing a high flow and quick response check valve (30, 130, 230, 330, 430) comprising:
assembling a housing (132, 232, 332, 432) having a plurality of inlet passages (138, 238, 338, 438) with a corresponding plurality of valve seats (148, 248, 348, 448), and an outlet passage (140, 240, 340, 440) in fluid communication with the inlet passages (138, 238, 338, 438) through a cavity (142, 242, 342, 442) extending therebetween;
positioning at least one valve disk (144, 244, 344, 444) having at least one valve sealing surface (146, 246, 346, 446) engageable with at least one of the corresponding plurality of valve seats (148, 248, 348, 448) into the cavity (142, 242, 342, 442) for reciprocal movement with respect to at least one of the corresponding plurality of valve seats (148, 248, 348, 448); and
biasing the at least one valve disk (144, 244, 344, 444) with at least one biasing member (150, 250, 350, 450) interposed between the housing (132, 232, 332, 432) and the at least one valve disk (144, 244, 344, 444), the at least one biasing member (150, 250, 350, 450) urging the at least one valve disk (144, 244, 344, 444) toward at least one of the corresponding plurality of valve seats (148, 248, 348, 448) while allowing reciprocal movement of the at least one valve disk (144, 244, 344, 444) from a seated sealed position to an unseated position spaced from the at least one of the corresponding plurality of valve seats (148, 248, 348, 448) allowing fluid flow therethrough.

12. The method of claim 11, wherein positioning at least one valve disk (144, 244) further comprises:
positioning a plurality of valve disks (144, 244); and
providing different fluid flow characteristics between the plurality of valve disks (144, 244), such that at least two of the plurality of valve disks (144, 244) have different fluid flow characteristic with respect to one another, the different fluid flow characteristics selected from a group including different valve disk sizes, different allowable valve disk travel distances, different valve disk biasing forces, and any combination thereof.

13. The method of claim 11 further comprising:
processing a sheet of metal material to define the plurality of inlet passages (138, 238) and the corresponding plurality of valve seats (148, 248);
forming the housing (132, 232) to define the outlet passage (140, 240); and
assembling the housing (132, 232) with respect to the processed sheet of metal material to define the cavity (142, 242) therebetween.

14. The method of claim 11, wherein positioning at least one valve disk (144, 244) further comprises:
positioning a plurality of valve disks (144, 244);
forming a connecting member (154, 254) to attach the plurality of valve disks (144, 244) with respect to one another into a single unitary valve disk member for synchronized reciprocal movement with respect to the corresponding plurality of valve seats (148, 248) between the seated sealed position and the unseated position allowing fluid flow therethrough; and
assembling the single unitary valve disk member including the connecting member (154, 254) and associated plurality of valve disks (144, 244) within the cavity (142, 242).

15. In a hydraulic tensioner (10) for an endless, flexible, power transmission member (12) for an internal combustion engine of a motor vehicle, the improvement of a high flow and quick response check valve (30, 130, 230, 330, 430) comprising:
a housing (132, 232, 333, 432) defining a plurality of inlet passages (138, 238, 338, 438) with a corresponding plurality of valve seats (148, 248, 348, 448), and an outlet passage (140, 240, 340, 440) in fluid communication with the plurality of inlet passages (138, 238, 338, 438) through a cavity (142, 242, 342, 442) defined therebetween;
at least one valve disk (144, 244, 344, 444) having at least one valve sealing surface (146, 246, 346, 446) engageable with at least one of the corresponding plurality of valve seats (148, 248, 348, 448), the at least one valve disk (144, 244, 344, 444) received within the cavity (142, 242, 342, 442) for reciprocal movement with respect to at least one of the corresponding plurality of valve seats (148, 248, 348, 448); and
at least one biasing member (150, 250, 350, 450) received within the cavity (142, 242, 342, 442) for biasing the at least one valve disk (144, 244, 344, 444) toward the at least one of the corresponding plurality of valve seats (148, 248, 348, 448) to a seated sealed position while allowing reciprocal movement of the at least one valve disk (144, 244, 344, 444) from the seated sealed position to an unseated position spaced from at least one of the corresponding plurality of valve seats (148, 248, 348, 448) allowing fluid flow therethrough.
